(19) United States
(12) Patent Application Publication
(10) Pub. No.: US 2005/0196498 A1
(43) Pub. Date: Sep. 8, 2005

(54) Applehead family craft kit and method for preparing apples

(76) Inventor: Joseph Douglas Gray, Oakland, CA (US)

Correspondence Address: SAWYER LAW GROUP LLP, P O BOX 51418, PALO ALTO, CA, 94303, US

(21) Appl. No.: 11/072,138

(22) Filed: Mar. 3, 2005

Related U.S. Application Data
(60) Provisional application No. 60/550,950, filed on Mar. 4, 2004.

(51) Int. Cl. A23L 1/00; A23B 7/16

(52) U.S. Cl. 426/383

(57) ABSTRACT

A method for forming an apple into a figure is disclosed. The method comprises peeling and shaping the apple utilizing a blade tool and a scraper tool; cutting outlines into the peeled and shaped apple, and punching out eye holes in the apple utilizing a hole punch. The method further comprises inserting teeth into the apple utilizing a tweezer; and allowing the apple to dry out over a predetermined time period.

### FIELD OF THE INVENTION

The present invention relates to a method for forming apples, and more particularly to a method for preparing apples in specific shapes and patterns.

### BACKGROUND OF THE INVENTION

It is desirable to form apples in a variety of shapes. The system and method should be cost effective, easy to implement and adaptable. The present invention addresses such a need.

### SUMMARY OF THE INVENTION

A method for forming an apple into a figure is disclosed. The method comprises peeling and shaping the apple utilizing a blade tool and a scraper tool; cutting outlines into the peeled and shaped apple, and punching out eye holes in the apple utilizing a hole punch. The method further comprises inserting teeth into the apple utilizing a tweezer; and allowing the apple to dry out over a predetermined time period.

### BRIEF DESCRIPTION OF THE DRAWINGS

FIG. 1 is a flow chart of a system for forming apples in accordance with the present invention.

### DETAILED DESCRIPTION

The present invention relates to a method for forming apples, and more particularly to a method for preparing apples in specific shapes and patterns. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The following tools are required to carry out the shaping and preparation of the apple in accordance with the present invention:
1. A blade, which is used to peel the apple.
2. A scraper, for shaping the apple.
3. A hole puncher, for creating the likeness of ears and eyes in the apple.
4. A tweezer, for inserting the teeth into the apple.
5. A cut-out pattern, which is utilized to determine the outlines to be cut into the apple.

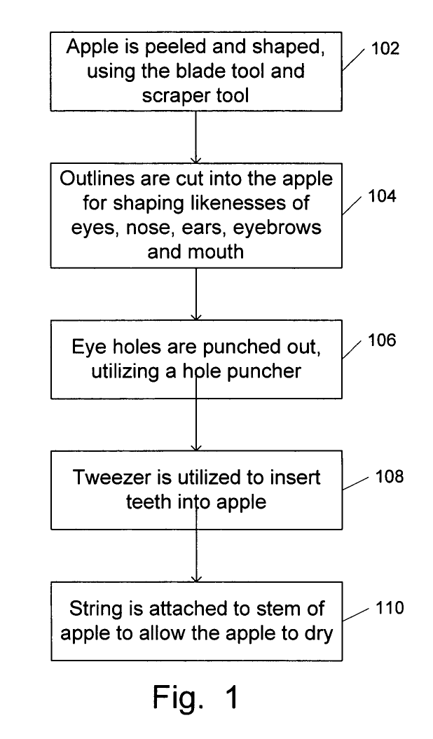

In order to shape and prepare an apple in accordance with the present invention, the following steps are undertaken as illustrated in FIG. 1. First, the apple is peeled and shaped, using the blade tool and the scraper tool, via step 102. Next, outlines are cut into the apple for shaping the likenesses of eyes, nose, ears, eyebrows and mouth in the apple, via step 104. Then, eye holes are punched out, utilizing a hole puncher, via step 106. A tweezer is utilized to insert teeth into the apple, via step 108. Last, a string is attached to the stem of the apple, via step 110. The apple is hung outside in the sun for approximately 3 to 4 days to allow it to dry. The full drying process may take up to 3 or 4 weeks. The diced apple is used as a “head” for an applehead figure.

The following accessories are also required to complete the patterning and shaping of the apple in accordance with the present invention:
1. An applehead stand.
2. Glue
3. Wax glaze
4. Eyes
5. Hair
6. Glasses
7. Bowtie
8. Tongue
9. Markers in black, blue, and red colors. However, other colors may be utilized and the apple would still be shaped and prepared in accordance with the features of the present invention. Accordingly, a plurality of applehead figures could be constructed in accordance with the a system and method in accordance with the present invention.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for forming an apple into a figure comprising:
peeling and shaping the apple utilizing a blade tool and a scraper tool;
cutting outlines into the peeled and shaped apple;
punching out eye holes in the apple utilizing a hole punch;
inserting teeth into the apple utilizing a tweezer; and
allowing the apple to dry out over a predetermined time period.

2. The method of claim 1 wherein the predetermined time period is between three and four weeks.

3. The method of claim 1 adding additional accessories to provide an applehead figure.

4. The method of claim 2 wherein the additional accessories comprise any combination of glue, wax glaze, hair, eyes, glasses, bowtie, tongue and color from a marker.
